(19) United States
(12) Patent Application Publication
(10) Pub. No.: US 2008/0059025 A1
(43) Pub. Date: Mar. 6, 2008

(54) VEHICLE STATE ESTIMATION SYSTEM

(75) Inventor: Takashi Furuichi, Wako-shi (JP)

Correspondence Address: RANKIN, HILL & CLARK LLP, 38210 Glenn Avenue, WILLOUGHBY, OH, 44094-7808, US

(73) Assignee: HONDA MOTOR CO., LTD., Tokyo (JP)

(21) Appl. No.: 11/846,225

(22) Filed: Aug. 28, 2007

(30) Foreign Application Priority Data
Aug. 29, 2006 (JP) 2006-231786

(51) Int. Cl. B60G 17/018; G06F 17/00

(52) U.S. Cl. 701/37

(57) ABSTRACT

A vibration model storage unit stores a vibration model which is made up of an unsprung part, a sprung part, a damper, a tire and a suspension spring, an actual relative distance detection unit detects an actual relative distance of the unsprung part to the sprung part, and a deviation calculation unit calculates a deviation between an estimated relative distance of the unsprung part to the sprung part that is estimated by the vibration model and the actual relative distance. An input parameter calculation unit calculates an input parameter that is inputted into the vibration model from a road surface based on the deviation calculated by the deviation calculation unit, and a vehicle state quantity calculation unit calculates a quantity of state of a vehicle by applying the input parameter to the vibration model.

This application claims priority to Japanese Patent Application No. 2006-231786, filed Aug. 29, 2006, in the Japanese Patent Office. The priority application is incorporated by reference in its entirety.

### TECHNICAL FIELD

The present disclosure relates to a vehicle state estimation system which enables a calculation of various quantities of state of a vehicle which include road surface displacement and sprung acceleration by applying an actual relative distance (a damper stroke) of a unsprung part to a sprung part of the vehicle to a vibration model of the vehicle.

### RELATED ART

A technique is known in U.S. Pat. No. 5,987,367 in which a relative speed of an unsprung part to a sprung part of a vehicle is estimated by applying a deviation between an acceleration of the sprung part that is detected by a sensor and an acceleration of the unsprung part that is estimated to a vibration model which is made up of an unsprung part, a sprung part, a damper, a tire and a suspension sprung.

Incidentally, since the aforesaid related-art technique handled a displacement (irregularities) of a road surface as a disturbance, the vibration model did not indicate accurately a vibrating state of a vehicle and hence had a problem that the accurate calculation of various quantities of state of a vehicle including road surface displacement was difficult.

### SUMMARY

Exemplary embodiments of the present invention provide a vehicle state estimation system which enable an accurate calculation of a quantity of state of a vehicle by the use of a vibration model.

According to a first aspect of the present invention, there is proposed a vehicle state estimation system including a vibration model storage unit for storing a vibration model made up of an unsprung part, a sprung part, a damper, a tire and a suspension spring, an actual relative distance detection unit for detecting an actual relative distance of the unsprung part to the sprung part, a deviation calculation unit for calculating a deviation between an estimated relative distance of the unsprung part to the sprung part that is estimated by the vibration model and the actual relative distance detected by the actual relative distance detection unit, an input parameter calculation unit for calculating an input parameter that is inputted into the vibration model from a road surface based on the deviation calculated by the deviation calculation unit, and a vehicle state quantity calculation unit for calculating a quantity of state of a vehicle by applying the input parameter calculated by the input parameter calculation unit to the vibration model.

According to a second aspect of the present invention, there is provided a vehicle state estimation system as set forth in the first aspect of the present invention, wherein the quantity of state of a vehicle that is calculated by the vehicle state quantity unit includes a sprung acceleration.

Note that a road surface displacement x0 which will be described in an exemplary embodiment corresponds to the input parameter of the present invention.

One or more embodiments of the present invention may include one or more the following advantages. For example, according to the configuration of the first aspect of the present invention, the vibration model storage unit stores the vibration model which is made up of the unsprung part, the sprung part, the damper, the tire and the suspension spring, the actual relative distance detection unit detects an actual relative distance of the unsprung part to the sprung part, and the deviation calculation unit calculates a deviation between an estimated relative distance of the unsprung part to the sprung part that is estimated by the vibration model and the actual relative distance detected by the actual relative distance detection unit. The input parameter calculation unit calculates an input parameter that is inputted into the vibration model from a road surface based on the deviation calculated by the deviation calculation unit, and the vehicle state quantity calculation unit calculates a quantity of state of a vehicle by applying the input parameter calculated by the input parameter calculation unit to the vibration model. Thus, since the quantity of state of the vehicle is calculated by inputting the input parameter calculated based on the deviation between the estimated relative distance and the actual relative distance of the unsprung part to the sprung part to the vibration model, a plurality of quantities of state of the vehicle including road surface displacement can be calculated with good accuracy only by detecting the actual relative distance.

In addition, according to the configuration of the second aspect of the present invention, since the quantity of state of a vehicle calculated by the vehicle state quantity calculation unit includes the sprung acceleration, the sprung acceleration that constitutes an important parameter used for a skyhook control can be calculated without a need for a sprung acceleration sensor.

Other features and advantages may be apparent from the following detailed description, the accompanying drawings and the claims.

### BRIEF DESCRIPTION OF THE DRAWINGS

FIG. 1 is a block diagram of a vehicle state estimation system according to an exemplary embodiment of the present invention.

FIG. 2 is an explanatory diagram which explains an operation of the system when a PID gain is set according to the exemplary embodiment of the present invention.

### DETAILED DESCRIPTION

Hereinafter, an exemplary embodiment of the present invention will be described based on the accompanying drawings.

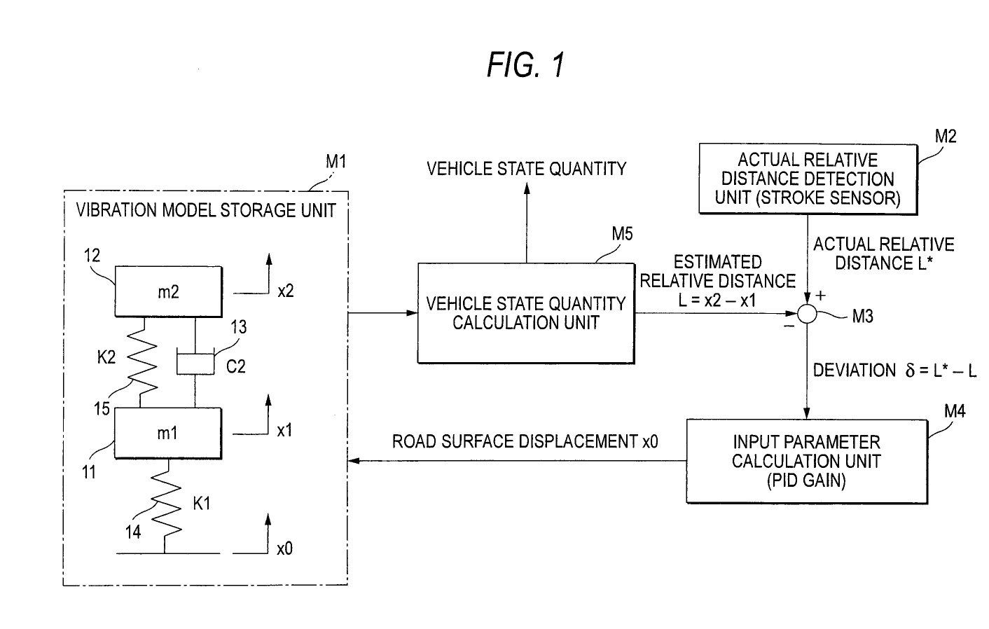

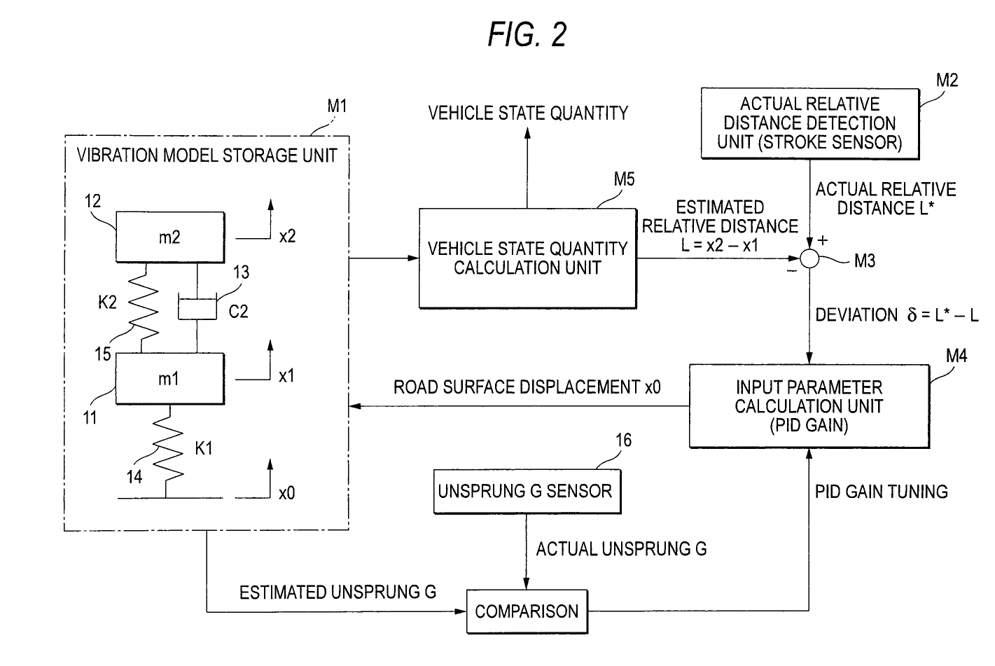

FIGS. 1 and 2 show an exemplary embodiment of the present invention, and FIG. 1 is a block diagram of a vehicle state estimation system, while FIG. 2 is an explanatory diagram which explains an operation of the system when a PID gain is set.

As is shown in FIG. 1, a vehicle state estimation system of the exemplary embodiment includes a vibration model storage unit M1, an actual relative distance detection unit M2, a deviation calculation unit M3, an input parameter calculation unit M4 and a vehicle state quantity calculation unit M5.

The vibration model storage unit M1 stores a vibration model which is made up of an unsprung part 11 which has an unsprung mass m1, a sprung part 12 which has a sprung mass m2, a damper 13 which has a damping coefficient C2, a tire 14 which has a spring constant K1, and a suspension spring 15 which has a spring constant K2. x0, x1, x2 are coordinate systems which are fixed in a space to extend in a perpendicular direction, x0, x1, x2 denoting respectively a displacement of a road surface (irregularities of the road surface), a displacement of the unsprung part 11, and a displacement of the sprung part 12.

The actual relative distance detection unit M2 is such as to calculate an actual relative distance L* which is an actual relative distance of the unsprung part 11 to the sprung part 12 and is specifically made up of a stroke sensor for detecting an extension stroke of the damper 13.

The deviation calculation unit M3 calculates a deviation δ=L*−L between an estimated relative distance L=(x2−x1) which is the relative distance of the unsprung part 11 to the sprung part 12 which is calculated (estimated) by the vehicle state quantity calculation unit M5 based on the vibration model stored in the vibration model storage unit M1 and an actual relative distance L* which is detected by the actual relative distance detection unit M2.

The input parameter calculation unit M4 calculates a road surface displacement x0 which is an input parameter inputted into the vibration model from the road surface by giving a PID gain to the deviation δ calculated by the deviation calculation unit M3. The PID gain is set in a way that will be described below. Namely, as is shown in FIG. 2, an unsprung acceleration sensor 16 for detecting an actual unsprung acceleration is temporarily provided on an actual vehicle, and an estimated unsprung acceleration which is estimated by the vibration model is compared to an actual unsprung acceleration detected by the unsprung acceleration sensor 16. Since the estimated unsprung acceleration changes according to the value of the PID gain, the PID gain is set (tuned) such that the estimated unsprung acceleration coincides with the actual unsprung acceleration. Since, when the setting of the PID gain is completed in this way, it is ensured that the vibration model accurately simulates the road surface displacement x0, unsprung displacement x1 and sprung displacement x2 of the actual vehicle, the unsprung acceleration sensor 16 becomes unnecessary and hence is removed.

Returning to FIG. 1, when the vibration model is vibrated based on, as an input, the road surface displacement x0 which is the input parameter calculated by the input parameter calculation unit M4, the vehicle state quantity calculation unit M5 calculates a plurality of quantities of state of the vehicle based on the vibrating state (road surface displacement x0, unsprung displacement x1 and sprung displacement x2) of the vibration model.

The quantities of state of the vehicle include road surface displacement which is nothing but x0, unsprung displacement which is nothing but x1, unsprung speed which corresponds to dx1/dt, unsprung acceleration which corresponds to d²x1/dt², sprung displacement which is nothing but x2, sprung speed which corresponds to dx2/dt, sprung acceleration which corresponds to d²x2/dt², stroke speed of the damper 13 which corresponds to d(x2−x1)/dt and the like.

Thus, since the PID gain is set such that the estimated unsprung acceleration estimated by the vibration model coincides with the actual unsprung acceleration detected by the unsprung acceleration sensor 16 and the vibration model is vibrated using the input road surface displacement x0 which is calculated based on the PID gain so set, the reliability in coincidence between the vibration model and the actual vehicle is enhanced, thereby making it possible to calculate the quantities of state of the vehicle with good accuracy.

In addition, since the road surface displacement x0 can be calculated, the road surface condition can be determined, which was not possible with the related-art technique described in U.S. Pat. No. 5,987,367 above. Moreover, since the sprung acceleration d²x2/dt² can be calculated, a skyhook control using the sprung acceleration d²x2/dt² can be performed without a need for a special sprung acceleration sensor.

Thus, while the embodiment of the present invention has been described heretofore, various modifications in design can be made to the present invention without departing from the spirit and scope thereof.

For example, the quantities of state of the vehicle which are calculated by the vehicle state quantity calculation unit M5 are not limited to road surface displacement, unsprung displacement, unsprung speed, unsprung acceleration, sprung displacement, sprung speed, sprung acceleration and stroke speed.

What is claimed is:

1. A vehicle state estimation system comprising:
a vibration model storage unit which stores a vibration model including an unsprung part, a sprung part, a damper, a tire and a suspension spring;
an actual relative distance detection unit which detects an actual relative distance of the unsprung part to the sprung part;
a deviation calculation unit which calculates a deviation between an estimated relative distance of the unsprung part to the sprung part that is estimated by the vibration model and the actual relative distance detected by the actual relative distance detection unit;
an input parameter calculation unit which calculates an input parameter that is inputted into the vibration model from a road surface based on the deviation calculated by the deviation calculation unit; and
a vehicle state quantity calculation unit which calculates a quantity of state of a vehicle by applying the input parameter calculated by the input parameter calculation unit to the vibration model.

2. A vehicle state estimation system as set forth in claim 1, wherein the quantity of state of a vehicle that is calculated by the vehicle state quantity unit includes a sprung acceleration.
